(19) United States
(12) Patent Application Publication
(10) Pub. No.: US 2013/0299564 A1
(43) Pub. Date: Nov. 14, 2013

(54) BRAZING PRE-FLUX COATING

(71) Applicants: Dagmar Steiner, Wedemark (DE); Jan Halvor Nordlien, Kolnes (NO); Jeffrey L. Insalaco, Rockledge, FL (US)

(72) Inventors: Dagmar Steiner, Wedemark (DE); Jan Halvor Nordlien, Kolnes (NO); Jeffrey L. Insalaco, Rockledge, FL (US)

(21) Appl. No.: 13/817,834

(22) PCT Filed: Aug. 22, 2011
(86) PCT No.: PCT/NO2011/000228

§ 371 Date: Jun. 26, 2013

(30) Foreign Application Priority Data
Aug. 23, 2010 (NO) 20101172

(51) Int. Cl. B23K 35/362

(52) U.S. Cl. CPC B23K 35/362
USPC 228/223; 428/451; 148/26; 148/24

(57) ABSTRACT

Pre-flux coating for the manufacturing of components by brazing, in particular manufacturing of heat exchangers of aluminium components including one or more fluxes and filler materials. The coating is composed of fluxes in the form of potassium aluminum fluoride K₁₋₃AIF₄₋₆, potassium trifluoro zincate, KZnF₃, lithium aluminum fluoride Li₃AIF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer. The potassium aluminium fluoride, K₁₋₃AIF₄₋₆ is a flux including KAIF₄, K₂AIF₅, K₃AIF₆ or a combination of these fluxes. The coating may be blended as a one layer coating or a multi layer coating, whereby as a one layer coating all flux components and filler material are mixed with binder and solvent, and whereby as a multi layer coating the flux components and filler material are mixed as separate coatings with binder and solvent.

The present invention is related to a pre-flux coating for the manufacturing of components by brazing, in particular manufacturing of heat exchangers of aluminium components including one or more fluxes and filler material(s).

Heat exchangers can either be mechanically assembled or they can be brazed. It is state of the art to braze aluminium heat exchanger in so-called CAB process which stands for Controlled Atmosphere Brazing. It is called Controlled Atmosphere as the brazing takes place under the protection of inert gas. Typically this is nitrogen. The known pre-flux coatings are combination of a flux and filler material. Flux is required to clean the surfaces of the aluminium parts from oxides and the filler metal is required for the metallic bonding.

Due to the fact that oxygen is nearly excluded in the furnace atmosphere (key process parameter for controlling the process), less aggressive types of flux can be used. Older brazing technologies used fluxes that were corrosive in nature and required post braze cleaning processes to remove corrosive flux residues. If not removed, early corrosion could occur in the field. The less aggressive fluxes so called non-corrosive fluxes, are mainly comprised of aluminium fluorides such as potassium aluminium fluoride. The required filler metal is usually a low melting aluminium alloy from AA4xxx series (containing silicon).

As stated above, aluminium heat exchangers are commonly used for automotive applications. Such heat exchangers are commonly used in air conditioning system, engine cooling system, engine oil cooling system and in automotive engine turbo-charger systems.

In addition to automotive applications, aluminium heat exchangers are now to an increasing extent being used for non-automotive applications such as industrial and residential applications performing similar functions as in automotive applications

Brazing heat exchangers using the Controlled Atmosphere Brazing process relies to a large extent on:
The flux (typically potassium aluminium fluoride)
The filler (typically from AA4xxx series)
The properties of the protective atmosphere (typically nitrogen), and
The elevated temperature exposure required to melt the filler material for metallic bonding.

The process parameters are modified depending on the type/size of heat exchanger to be brazed as well as the types of filler metal and flux compounds used.

Common practice for creating a metallic bond in a heat exchanger is by having one of the two components being joined to be clad with AA4xxx series (ex. clad fin and non-clad tube). A general application of flux (as defined previously) is applied to the entire heat exchanger assembly prior to brazing.

A new type of braze coating does away with the requirement of having one of the components made from clad material (AlSi material). This coating type is called Silflux™ (made by Solvay), which has been introduced by the applicant under the trade name HYBRAZ™/®. HYBRAZ simplifies the heat exchanger manufacturing process by doing away with the need of general flux application. Besides simplifying the manufacturing process, HYBRAZ also offers several benefits to the finished heat exchanger. Some benefits are: The elimination of plugged fin louvers associated with general flux application that reduces heat exchanger performance. Less flux residue on the fin and tube allowing for the application of post braze hydrophilic coatings. The benefits of the HYBRAZ coating are evident in the market due to the increased demand for HYBRAZ™/® coated Multi Port Extruded (MPE) tubes.

Besides HYBRAZ MPE tubes, HYBRAZ can be used for other components that make up a heat exchanger design such as welded tubes or folded tubes).

Depending on the application the tube can be coated using the HYBRAZ process with materials containing fluxes and/or filler alloy.

For corrosion protection of brazed aluminium components, a protective layer can be used. The protective layer can in general be of the following two types:
Passive
Sacrificial

A passive layer is a coating that is chemically passive (dead) and covers the surface. On the other hand, a sacrificial layer is a layer which is less noble than the core material. It will result in lateral corrosion when exposed to aggressive environment. A typical sacrificial layer on aluminium is the application of a zinc layer. This zinc layer can be applied to the aluminium surface by zinc arc spraying. Metallic zinc is applied to the MPE surface typically in line during the extrusion process. Full corrosion protection occurs after the tube has passed through a brazing cycle and a zinc diffusion gradient is formed into the tube.

As an alternative to the zinc arc spray application of zinc to an aluminium component surface as mentioned above, there is now a significant interest in using reactive Zn flux on the aluminium surface. The HYBRAZ™/® coated products containing reactive Zn flux will provide flux for brazing as well as a Zn diffusion gradient into the tube for corrosion protection. Zn flux is a so called reactive flux from potassium fluorozincate type, generating brazing flux and metallic zinc during the brazing cycle. The metallic zinc forms a Zn gradient into the Al tube as a sacrificial layer. When using Zn flux, clad fin is needed to braze the fin-tube joints.

With the present invention multiple coating variants can be derived using the HYBRAZ process:
Braze material for joint formation
Zn for corrosion protection
Flux for removing the oxide layer
Li for limiting water solubility of flux residues and therefore limited attack from stationary water.

The invention is characterized by the features as defined in the attached independent claim 1.

Preferred embodiments are further defined in the subordinate claims 2-9.

The invention will now be further described in the following by way of examples.

The major focus within the applicant's work on combining a braze material and Zn containing flux for corrosion protection was, as mentioned above, on automotive applications, even though there is an interest for non-automotive applications as well. In particular on heat exchanger applications where stationary water might influence to the heat exchanger, additional corrosion protection, beyond sacrificial Zn protection is desired.

It was known by the inventors that residual flux layer improves the corrosion resistance compared to bare aluminium components, i. e. aluminium parts without any coating at all. This is due to the low water solubility of the flux residues. A very low dissolution of flux residues takes place under the conditions in automotive applications. The exposure to water in non-automotive applications is different. The aluminium parts are dependent on their location exposed to the atmosphere, which might include exposure to stationary water.

For further development of the applicant's HYBRAZ™/® coated products, the inventors decided to introduce Li-containing flux into the flux coatings for Al tubes used in heat exchangers since this flux after brazing provides flux residues on the surface of the product that show limited water solubility and therefore reduced attack from dissolved fluorides to the aluminium surface.

With the present invention is thus provided a novel pre-flux coating which provides both sacrificial and passive protection and which, at the same time provides braze (filler) material for the joint formation and flux for removal of oxide layer.

Hence, the pre-flux coating according to the present invention is based on a mixture of flux particles from different fluxes with different properties, as well as Si particles as filler material and including a solvent and binder. More precisely the present invention is composed of fluxes in the form of potassium aluminum fluoride (K₁₋₃ AlF₄₋₆), potassium trifluoro zincate (KZnF₃), lithium aluminum fluoride Li₃AlF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer.

The potassium aluminium fluoride (K₁₋₃Al_{F4}-₆) as mentioned above can be KAlF₄ and K₂AlF₅ and K₃AlF₆ or a combination of these. This is a product from a real synthesis. Potassium trifluoro zincate, KZnF₃ is added for corrosion protection.

The potassium fluoro silicate K₂SiF₆ reacts with Al and generates Si metal, which forms AlSi12 as filler metal. Further, lithium aluminium fluoride Li₃AlF₆ is added for limiting water solubility of flux residues and therefore limited attack from stationary water. Correct composition is required for effect from post-braze flux residues.

For alloys with high Mg, optionally potassium aluminum fluoride (see above) plus cesium aluminium fluoride CsAlF₄, mechanically blended, may be added.

As to the composition of the coating materials, the content of solvent may preferably be approximately 30 wt % depending on the desired application properties. Further the ratio of particles and binder may vary from 3:1 to 4:1.

Additional thickener might be added to the coating material (cellulose), content approx. 14 wt % related to acrylic binder.

The ratio of particles of the different fluxes may vary as is apparent from the table below.

The coating as applied on an aluminium component may further vary with different total load between 8 g/m² and 16 g/m². See as well in this connection the table below.

TABLE
(particle content):

| | | Zn Flux | Flux | Li Flux |
|---|---|---|---|---|
| | Silicon (Si) | (KZnF₃) | (KAlF₄/ | (Li₃AlF₆) |
| | g/m² | g/m² | K₃AlF₆) g/m² | g/m² |
| Ratio (coating) | 0-4.5 | 2-16 | 4-8 | 0.1-5 |
| Ratio (load) | 0-5.2 | 1.41-16 | 2.2-9.2 | 0.1-5 |

The coating is produced by mixing based on the following sequence:
blending of solvent and binder by stirring in a suitable blender, and
adding of the flux particles to the solvent and binder composition under continuous stirring.
thorough mixing of the composition until desired quality with respect to specified parameters of the coating material is obtained.

Upon application of the coating on the components to be brazed, the coating is again subjected to stirring to guarantee a homogenous coating material. During the stirring operation viscosity of the coating is adjusted according to the application process and equipment.

Drying of coated components may take place in a separate drying process, e.g. using IR light or other heating sources.

It should be stressed that the invention as defined in the claims is not restricted to the example as described above. Thus, the coating may be blended and applied as a one layer coating or a multi layer coating.

One layer coating represents the preferred embodiment of the invention and implies that all flux components are mixed with binder and solvent and are applied in one step to the aluminium surface.

As a multi layer coating is understood that the coating is mixed as separate coatings with binder and solvent and can be applied in 2, 3 or 4 layers as follows:
2 layer coating:
   In a first layer flux, potassium aluminum fluoride, and filler material or filler generating material are applied to the aluminium surface.
   In a second layer potassium trifluoro zincate is applied.
   The coating with Li flux content can be applied either in the first or in the second layer.
The opposite direction of the two layers is possible too, with potassium trifluoro zincate as first layer.
3 layer coating:
   Each component is applied as a single coating layer.
   Flux coating layer
   Filler material or filler generating material coating layer.
   Potassium trifluoro zincate coating layer.
   The Li content can be applied within each of the coating layers
4 layer coating:
   Each component is applied as a separate coating layer as with the 3 layer above, but
   The Li content is applied as a single layer as well.

In the case of a multi layer coating it will be important to control the total amount of binder to avoid any trouble from too high content of organic resin and therefore trouble in brazing.

In case of a multi layer coating some of the layers might be discontinuously applied.

As to how the pre-flux coating may be provided on an aluminium component, any technique may be used such as roll coating, dip coating, spray coating or even screen printing.

1. Pre-flux coating for the manufacturing of components by brazing, in particular manufacturing of heat exchangers of aluminium components including one or more fluxes and filler material,
characterized in that
the coating is composed of fluxes in the form of potassium aluminum fluoride K₁₋₃AlF₄₋₆, potassium trifluoro zincate, KZnF₃, lithium aluminum fluoride Li₃AlF₆, filler material in the form of metallic Si particles, Al—Si particles and/or potassium fluoro silicate K₂SiF₆, and solvent and binder containing at least 10% by weight of a synthetic resin which is based, as its main constituent, on methacrylate homopolymer or methacrylate copolymer.

2. Coating according to claim 1,
characterized in that the coating is blended as a one layer coating or a multi layer coating, whereby as a one layer coating all flux components and filler material are mixed with binder and solvent, and whereby as a multi layer coating the flux components and filler material are mixed as separate coatings with binder and solvent.

3. Coating according to claim 1,
characterized in that the multilayer coating includes 2, 3 or 4 individually blended coating elements each based on binder and solvent with one or more flux component and/or filler material or filler generating material.

4. Coating according claim 1,
characterized in that
the potassium aluminum fluoride, K₁₋₃ AlF₄₋₆ is a flux including KAlF₄, K₂AlF₅, K₃AlF₆ or a combination of these fluxes.

5. Coating according to claim 1 where the aluminium component is based on an aluminium alloy with high Mg content,
characterized in that
an additional flux in the form of cesium aluminum fluoride CsAlF₄ is added.

6. Coating according to claim 1,
characterized in that
the ratio of particles and binder is between 3:1 to 4:1.

7. Coating according to claim 1,
characterized in that
the ratio of particles of the different components of the coating corresponds to a load of 0-5.2 g/m²Si, 1.41-16 g/m²Zn flux (KZnF₃), 2.2-9.2 g/m² potassium flux (KAlF₄/K₃AlF₆) and 0.1-5 g/m²Li flux (Li₃AlF₆) g/m².

8. Application of the coating on an aluminium component according to claim 1 as a one layer coating or a multi layer coating, whereas as a one layer coating all flux components and filler material are mixed with binder and solvent and provided on the component in one operation, and whereas as a multi layer coating the flux components and filler material are mixed as separate coatings with binder and solvent and applied individually one at a time preferably with intermediate curing.

9. Application according to claim 8 where the coating is provided on the component by roll coating or dip coating.
